(19) United States
(12) Patent Application Publication
(10) Pub. No.: US 2012/0299996 A1
(43) Pub. Date: Nov. 29, 2012

(54) INK JET PRINTING APPARATUS

(75) Inventors: Yutaka Kano, Yokohama-shi (JP); Hidehiko Kanda, Yokohama-shi (JP); Susumu Hirosawa, Tokyo (JP); Kentarou Muro, Tokyo (JP)

(73) Assignee: CANON KABUSHIKI KAISHA, Tokyo (JP)

(21) Appl. No.: 13/569,344

(22) Filed: Aug. 8, 2012

Related U.S. Application Data
(63) Continuation of application No. PCT/JP2012/000919, filed on Feb. 10, 2012.

(30) Foreign Application Priority Data
Feb. 10, 2011 (JP) 2011-027195

(51) Int. Cl. B41J 2/165

(52) U.S. Cl. 347/33

(57) ABSTRACT

An ink jet printing apparatus is disclosed that can more appropriately clean the nozzle faces of line-type print heads. The apparatus includes: a print head having nozzle chips, each having nozzle arrays arrayed on a common chip mounting face of the print head; a first cleaning unit configured to wipe the chip mounting face including wiping nozzle faces of the nozzle chips; a second cleaning unit configured to suction the chip mounting face including suctioning nozzle faces; a moving mechanism configured to move the first and second cleaning units relative to the print head in a first cleaning direction and in a second cleaning direction opposite to the first cleaning direction; and a selection unit configured to select a cleaning unit to be used for cleaning in the first and second cleaning directions from the first and second cleaning units, respectively.

### BACKGROUND OF THE INVENTION

1. Field of the Invention

The present invention relates to an ink jet printing apparatus.

2. Description of the Related Art

A cleaning mechanism is disclosed, in a Japanese Patent Laid-Open No. H6-135004 (1994), which includes a flexible blade, used to scrape paper powder and dust around the nozzles of the print head of an ink jet printing apparatus, and a suction unit for drawing in, using suction, bubbles that have entered the nozzles and ink that has become viscous and is attached to the inside the nozzles. The cleaning mechanism moves the flexible blade and the suction unit in a direction along the nozzle arrays to scrape the paper powder and dust that are attached to the peripheries of the nozzles, while drawing in, using suction, bubbles that entered in the nozzles and ink that has become viscous and is attached inside the nozzles.

For so-called line-type print heads where a plurality of nozzle chips are regularly arranged, e.g., staggered, seal portions for sealing wiring are provided for the nozzle formation face of each print head. Since the seal portions are projected from the nozzle formation face, a difference in level is present between the seal portions and the nozzle forming face.

When the cleaning mechanism disclosed in Japanese Patent Laid-Open No. H6-135004 (1994) is employed to clean the nozzle formation faces of the line-type print heads described above, paper powder and dust scraped off by the blades tend to be collected at a level difference. Furthermore, since the blade and the suction unit are integrally formed for the cleaning mechanism and the suction process using the suction unit is performed immediately after wiping using the blades is performed, paper powder and dust collected at the level difference can not be appropriately drawn in.

### SUMMARY OF THE INVENTION

One objective of the present invention is to provide an ink jet printing apparatus that can more appropriately clean the nozzle faces of line-type print heads, for each of which a plurality of nozzle chips are regularly arranged.

An ink jet printing apparatus of the present invention includes:

a print head having a plurality of nozzle chips, each having nozzle arrays arrayed on a common chip mounting face of the print head;

a first cleaning unit configured to wipe the chip mounting face of the print head including wiping nozzle faces of the nozzle chips;

a second cleaning unit configured to suction the chip mounting face including suctioning nozzle faces of the nozzle chips;

a moving mechanism configured to move the first and second cleaning units relative to the print head in a first cleaning direction and in a second cleaning direction opposite to the first cleaning direction; and

a selection unit configured to select a cleaning unit to be used for cleaning in the first cleaning direction and a cleaning unit to be used for cleaning in the second cleaning direction, from the first and second cleaning units, respectively.

According to the present invention, the nozzle formation faces of the line-type print heads, where a plurality of nozzle chips are regularly arranged, can be more appropriately cleaned.

Further features of the present invention will become apparent from the following description of exemplary embodiments (with reference to the attached drawings).

### BRIEF DESCRIPTION OF THE DRAWINGS

FIG. 1 is a perspective view of the essential portion of a printing apparatus according to a first embodiment of the present invention;

FIG. 2 is a cross-sectional view of the essential portion of the printing apparatus;

FIG. 3 is a cross-sectional view of the printing apparatus in a cleaning operation;

FIG. 4A is a side view of the structure of a print head;

FIG. 4B is a front view of the structure of the print head;

FIG. 5A is a front view of the structure of a nozzle chip;

FIG. 5B is a cross-sectional view of the structure of the nozzle chip;

FIG. 6 is an enlarged partial diagram showing the positional relationship between nozzle chips and suction nozzles;

FIGS. 7 and 8 are perspective views of the structure of a cleaning mechanism;

FIG. 9 is a diagram illustrating the structure of a cleaning unit;

FIGS. 10A to 11B are perspective views of the operations for changing the position of blades;

FIGS. 12A and 12B are perspective views of the operation of the cleaning mechanism;

FIG. 13 is a perspective view of the structure for a positioning member;

FIG. 14 is a diagram showing the structure of the positioning member;

FIGS. 15A to 15C are diagrams showing the states of the positioning member and a head positioning member when the cleaning operation is performed;

FIG. 16 is a flowchart showing the operation of the cleaning mechanism performed for the first embodiment of the present invention;

FIG. 17A is a diagram showing the state, for the first embodiment, before a blade is moved from a nozzle face to a seal portion;

FIG. 17B is a diagram showing the state, for the first embodiment, after the blade has moved from the nozzle face to the seal portion;

FIG. 18A is a diagram showing the state, for the first embodiment, before suction nozzles are moved from the seal portion to the nozzle face;

FIG. 18B is a diagram showing the state, for the first embodiment, after the suction nozzles have moved from the seal portion to the nozzle face;

FIG. 19 is a flowchart showing the operation of a cleaning mechanism performed for a second embodiment of the present invention;

FIG. 20A is a diagram showing the state, for the second embodiment, before suction nozzles are moved from a nozzle face to a seal portion;

FIG. 20B is a diagram showing the state, for the second embodiment, after the suction nozzles have moved from the nozzle face to the seal portion;

FIG. 21A is a diagram showing the state, for the second embodiment, before the suction nozzles are moved form the seal portion to the nozzle face; and

FIG. 21B is a diagram showing the state, for the second embodiment, after the suction nozzles have moved from the seal portion to the nozzle face.

### DESCRIPTION OF THE EMBODIMENTS

### First Embodiment

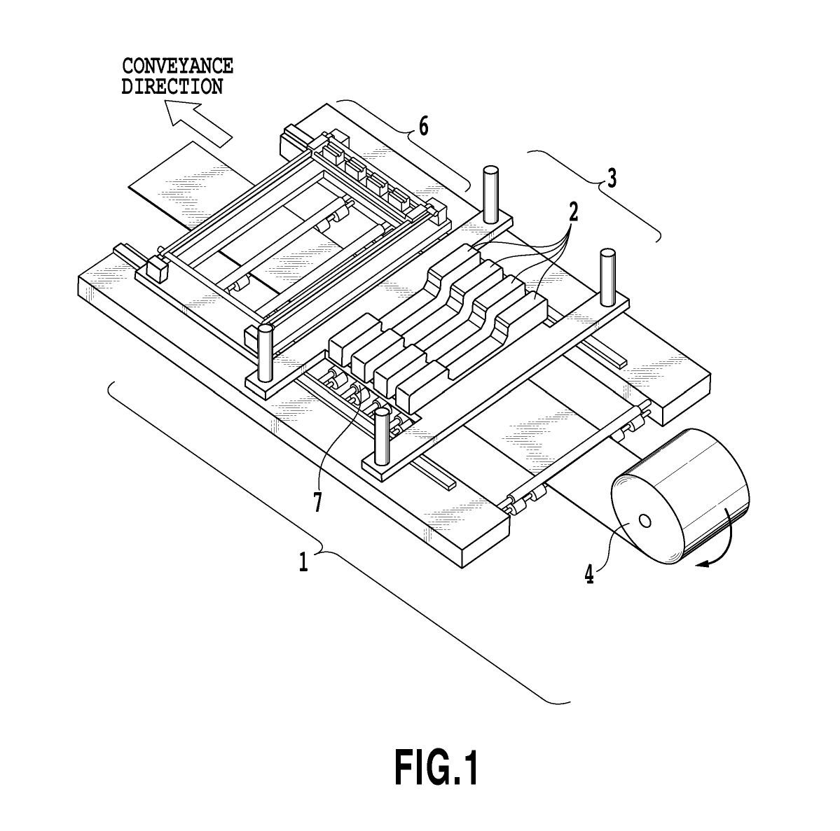

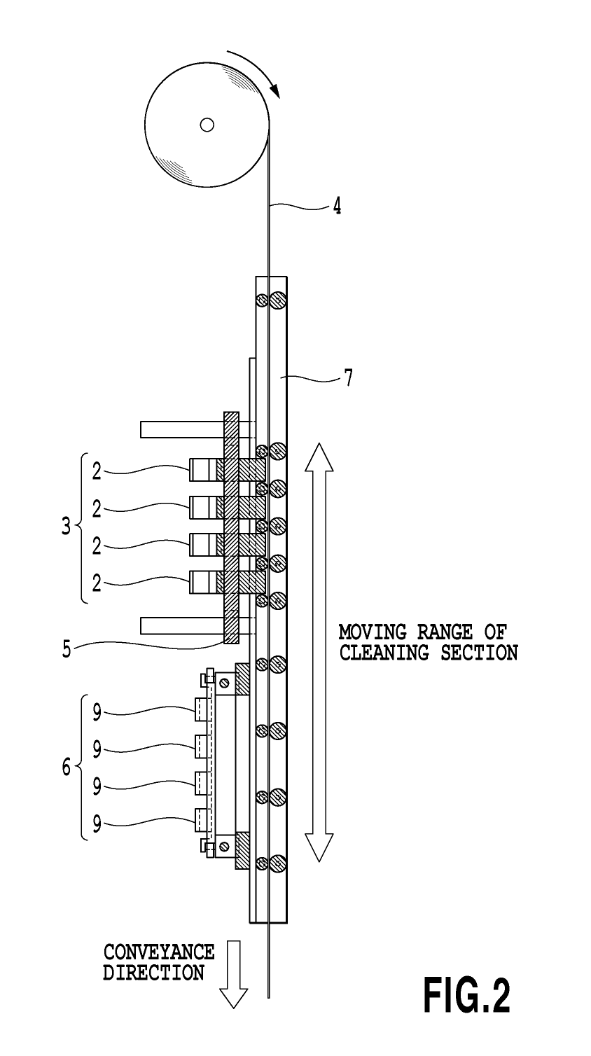

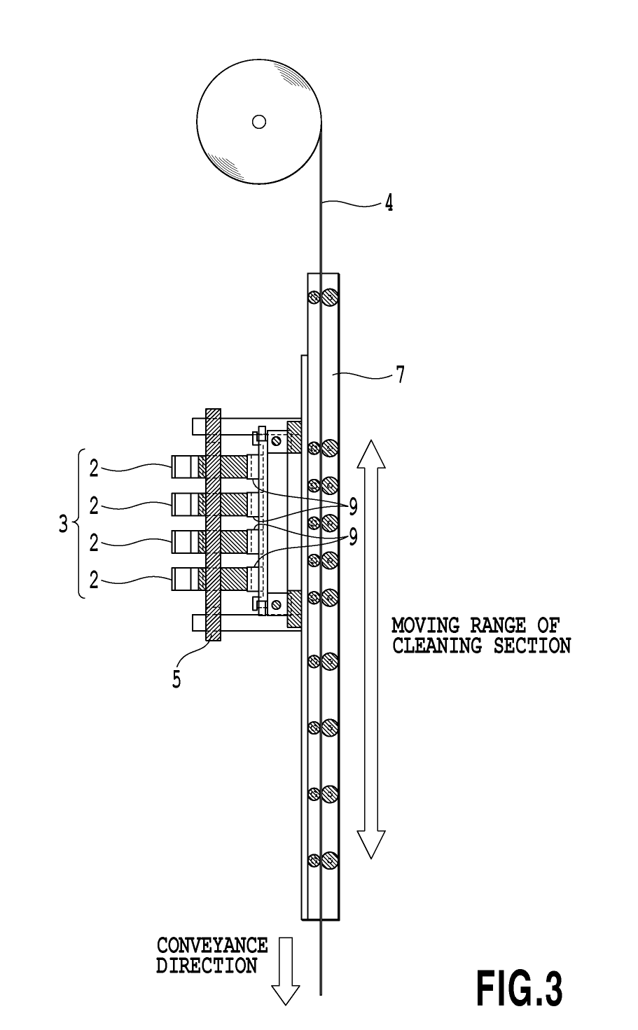

A first embodiment of the present invention will be specifically described while referring to the accompanying drawings. FIG. 1 is a perspective view of the structure of the essential portion, which primarily includes the printing portion of an ink jet printing apparatus according to this embodiment, and FIG. 2 is a cross-sectional view of the structure of the apparatus in FIG. 1. FIG. 3 is a cross-sectional view of the state when the cleaning operation is performed.

An ink jet printing apparatus 1 (hereinafter, referred to as a printing apparatus 1) in the present embodiment is a line printer that prints using a long line-type print head assembly, while continuously conveying a sheet in a conveyance direction (a first direction). The printing apparatus 1 includes a holder to hold a rolled sheet 4 of, for example, continuous forms, a conveyance mechanism 7 for conveying the sheet 4 in the first direction at a predetermined speed, and a printing unit 3 for printing on the sheet 4 using the line-type print head assembly. It should be noted that the sheet employed is not always a rolled sheet in continuous forms, and a cut sheet may be employed. The printing apparatus 1 also includes a cleaning section 6 for wiping the nozzle faces of print heads. Further, a cutting unit for cutting the sheet 4, a drying unit for forcibly drying the sheet 4 and a discharge tray are provided downstream from the printing unit 3 along a sheet conveyance path.

The printing unit 3 includes a plurality of print heads 2 which eject different color of inks, respectively. In the present embodiment, four print heads 2 are employed corresponding to four colors, CMYK; however, the number of colors is not limited to four. The individual color inks are supplied from corresponding ink tanks via ink tubes to the print heads 2. The print heads 2 are held in a single head holder 5, and a mechanism for moving the head holder 5 up and down is included so as to change distances between the print heads 2 and the surface of the sheet 4. Further, a mechanism for moving the head holder 5 parallel to a direction (a second direction) that is perpendicular to the first direction.

The cleaning section 6 includes a plurality of (four) cleaning mechanisms 9 corresponding to the plurality of (four) print heads 2. A detailed description for these cleaning mechanisms 9 will be given later. The cleaning section 6 is formed to be slidable in the first direction and driven by a drive motor (not shown). The states shown in FIGS. 1 and 2 are those during printing, and the cleaning section 6 is located downstream from the printing unit 3 in the sheet conveyance direction. The state in FIG. 3 is one during the cleaning operation, and the cleaning section 6 is located immediately below the print heads 2 of the printing unit 3. In FIGS. 2 and 3, the movable range of the cleaning section 6 is indicated by arrows.

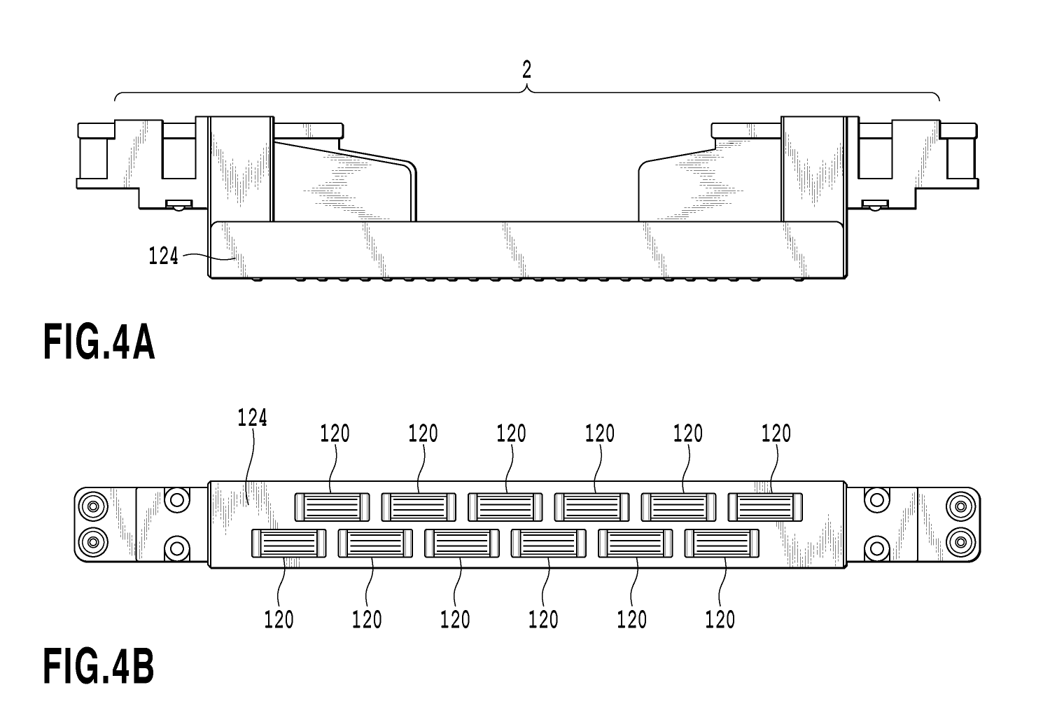

The structure for one of those print heads 2 is shown in FIGS. 4A and 4B. For ink jet printing, a method employing heat generating elements, a method employing piezoelectric elements, a method employing electrostatic elements, or a method employing MEMS elements is employed. The print head 2 is a line-type print head, for which ink jet type nozzle arrays are formed in a range that covers the maximum width of a sheet that is supposed to be employed. A direction in which the nozzle arrays are provided is a direction (the second direction) that intersects the first direction, e.g., a perpendicular direction. A plurality of nozzle chips 120 are arranged on a base substrate 124 (a face used in common), in the longitudinal direction (the second direction). As shown in FIG. 4B, a plurality of (twelve in this embodiment) nozzle chips 120 having the same size and the same structure are regularly provided to form two staggered arrays across the entire area in the longitudinal direction. That is, in the print head 2, the nozzle chips 120, each of which includes nozzle arrays, are provided as a first nozzle chip array and a second nozzle chip array in the longitudinal direction (the second direction), and the positions of the first nozzle chip array and the second nozzle chip array, which are adjacent to each other, are shifted away from each other in the longitudinal direction. For the nozzle chips 120 of the first array and the nozzle chips 120 of the second array that are adjacent to each other, the nozzle arrays included in these nozzle chips 120 partially overlap in the second direction.

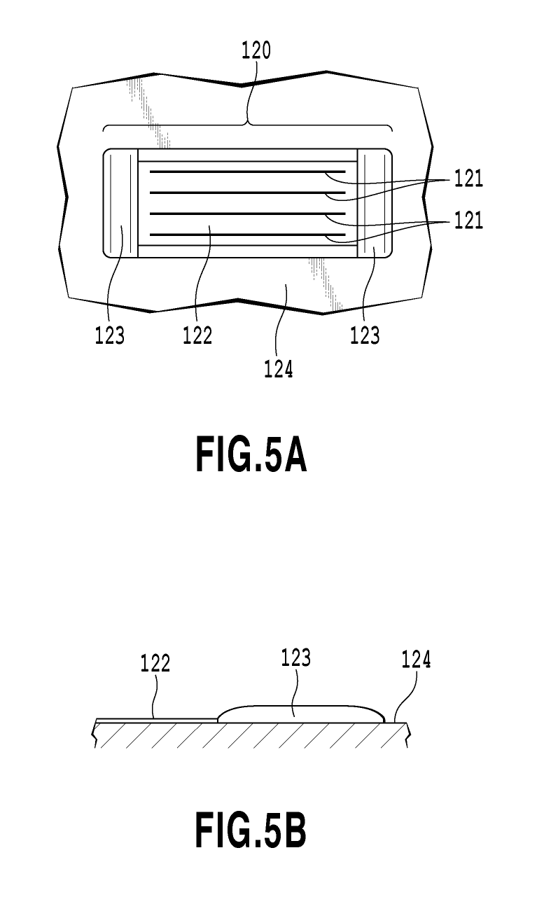

The structure of one of those nozzle chips 120 included in the print head 2 is shown in FIGS. 5A and 5B. The nozzle chip 120 includes a nozzle face 122, where a plurality of (four in this embodiment) nozzle arrays 121 for ink ejection are formed, and a nozzle substrate in which energy elements are formed and embedded in consonance with the individual nozzles. The four nozzle arrays 121 are arranged parallel to each other in the first direction, and the nozzle substrate of the nozzle chip 120 is formed on the base substrate 124. The nozzle substrate and the base substrate 124 are connected by an electric connector, which is covered with seal portions 123 made of a resin material, in order to protect from corrosion and wire snaps. Referring to FIG. 5B, when the nozzle face 122 is viewed from the side, the seal portions 123 are formed on the base substrate 124 and are projected further than the nozzle face 122 in the ink ejection direction (referred to as a third direction). For each of the nozzle chips 120, the seal portions 123 are located near the two end portions of the nozzle face 122 in the direction (the second direction) in which the nozzle arrays 121 are formed. As described above, the seal portions 123 are formed, by a gentle slope, near the plurality of nozzle arrays 121, so that the seal portions 123 are projected further than the nozzle face 122 in the ink ejection direction.

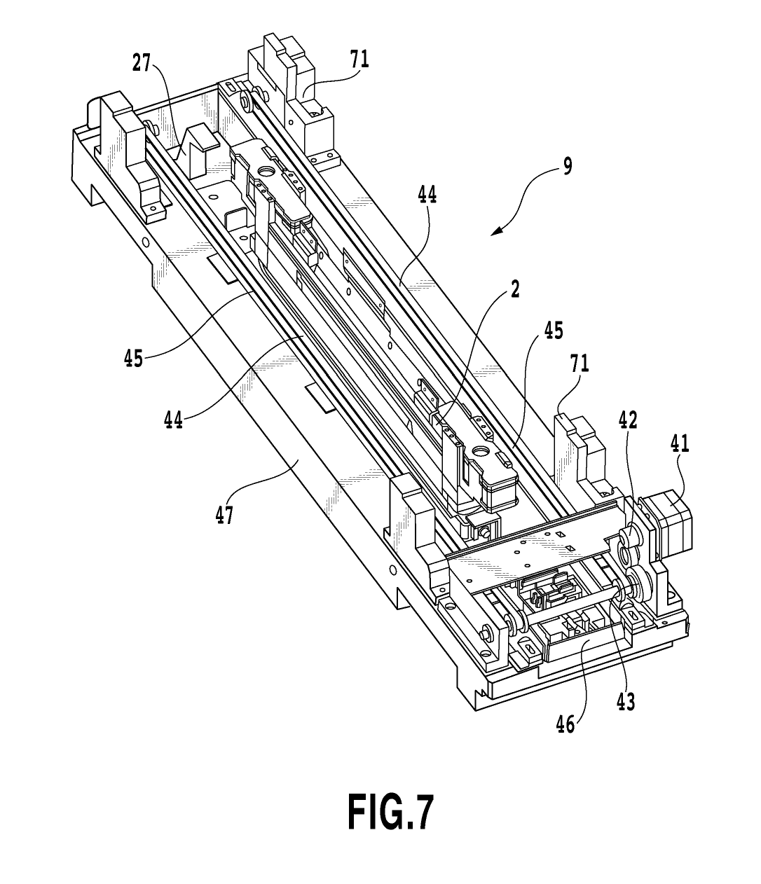

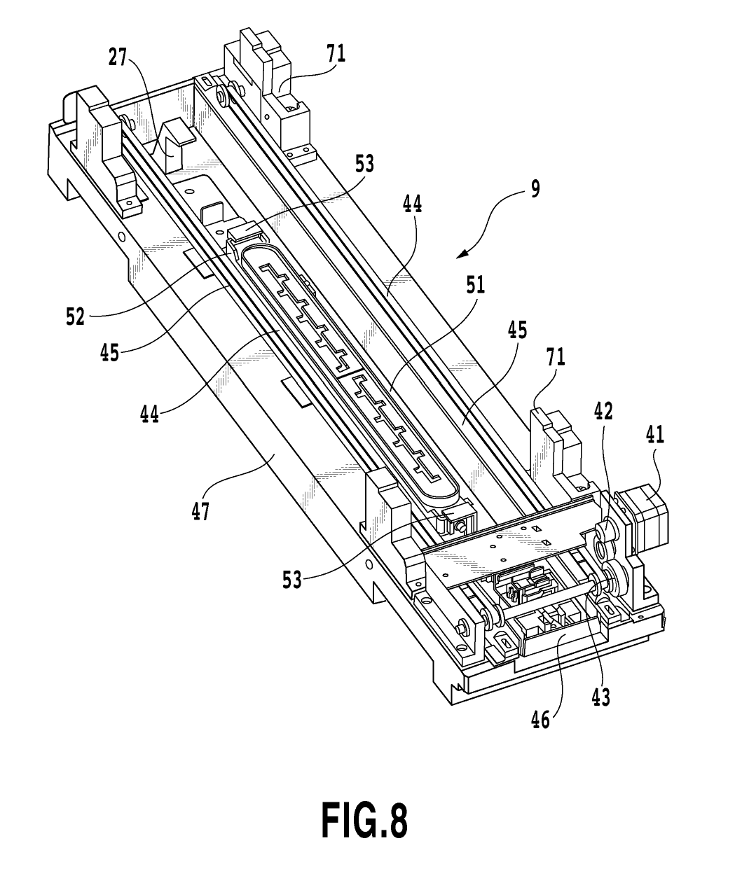

FIGS. 7 and 8 are perspective views of a detailed structure for one of the cleaning mechanisms 9 provided for the cleaning section 6. The state in FIG. 7 is the state wherein the cleaning mechanism 9 is present below the print head 2 (the state during the cleaning operation), and the state in FIG. 8 is the state wherein the print head 2 is not present above the cleaning mechanism 9, so that the cleaning mechanism 9 is exposed. The cleaning mechanism 9, a cap 51 and positioning members 71 are included in the cleaning section 6.

The cleaning mechanism 9 includes a cleaning unit 46, for wiping the nozzle faces of the print head 2 to remove ink and dust therefrom, and a moving mechanism for moving the cleaning unit 46 in a cleaning direction (the longitudinal direction of the print head 2, i.e., the second direction), and a frame 47 for together supporting these components. The cleaning unit 46 is a unit with which wiper blades and suction nozzles that will be described later can be moved together. The moving mechanism is to be driven by a drive source so as to reciprocate the cleaning unit 46 along two shafts 45, in the longitudinal direction of the print head 2. The drive source includes a drive motor 41 and speed reduction gears 42 and 43 to rotate a drive shaft 37. The rotation of the drive shaft 37 is transmitted by belts 44 and a pulley to move the cleaning unit 46, which, as will be described later, employs both wiper blades and suction nozzles to remove ink and dust from the nozzle faces 122 of the print head 2. A trigger lever 27 is provided outside the cleaning area of the frame 47 in order to change the direction of the blades that will be described later.

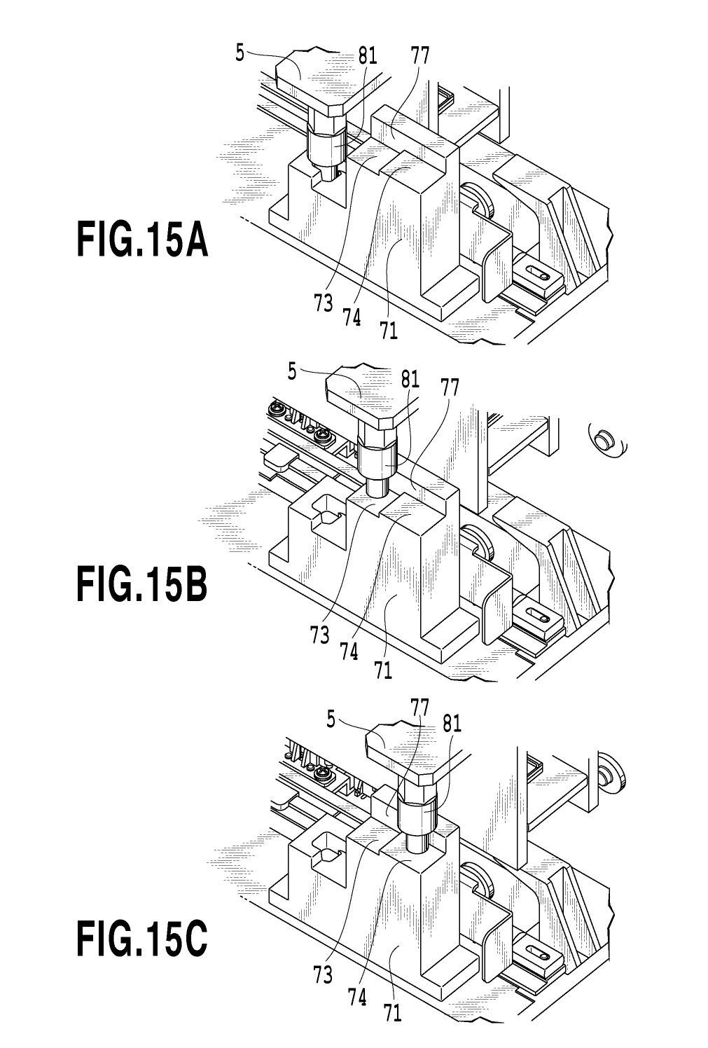

In FIG. 8, the cap 51 is held by a cap holder 52. The cap holder 52 is urged by a spring, which is a flexible member, in a direction perpendicular to the nozzle faces 122 of the print head 2, and is movable against the force of the spring. In the state wherein the frame 47 is located at the position of the cap 51, the print head 2 is moved, in a direction perpendicular to the nozzle faces 122 to closely contact, or separate from, the cap 51. When the print head 2 closely contacts the cap 51, the nozzle faces are covered to prevent drying of the nozzles. Since in the cleaning operation and in the capping operation, the positioning members 71 are brought into contact with head positioning members 81 (not shown in FIG. 8, and see FIG. 15), provided for the head holder 5, the positional relationship between the print head 2 and the cleaning section 6 is determined for the first direction, the second direction and the direction (the third direction) perpendicular to the nozzle faces 122.

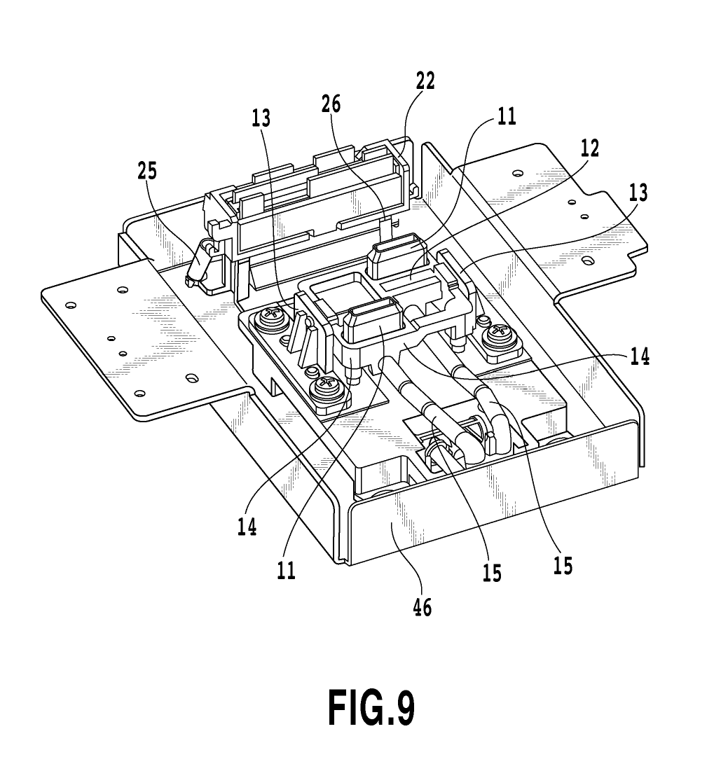

FIG. 9 is a diagram showing the structure of the cleaning unit 46. Two suction nozzles 11 are arranged as suction means in consonance with the first and second nozzle chip arrays. The pitch of the two suction nozzles 11 in the first direction is the same as that of the two nozzle chip arrays. For the second direction, the two suction nozzles 11 are located with the same predetermined shift (a predetermined distance) as used for the nozzle chips of the two nozzle chip arrays that are adjacent to each other. The suction nozzles 11 are held in a suction holder 12, which is urged, by a spring 14 that is a flexible member, in the direction (the third direction) perpendicular to the nozzle faces 122 of the print head 2, and is displaceable against the spring 14 to the third direction. This displacement mechanism is to absorb movements of the suction nozzles 11 when they are climbing over the seal portions 123. This mechanism will be described later in detail.

Tubes 15 are connected to the two suction nozzles 11 via the suction holder 12, and a pressure-reduction device, such as a suction pump, is connected to the tubes 15. When the pressure-reduction device is actuated, the internal pressure of the suction nozzles 11 is reduced to draw in ink and dust. Two blades 21 on either side, for a total of four blades 21, are held in a blade holder 22. The blade holder 22 is supported at the two ends in the first direction so as to be rotatable at the first directional axis, and is normally urged against a stopper 26 by a spring 25. The direction for the blade faces of the blades 21 can be switched between a cleaning enabling position and a retracted position by a switching mechanism that will be described later. The suction holder 12 and the blade holder 22 are arranged on a support member employed in common for the cleaning unit 46.

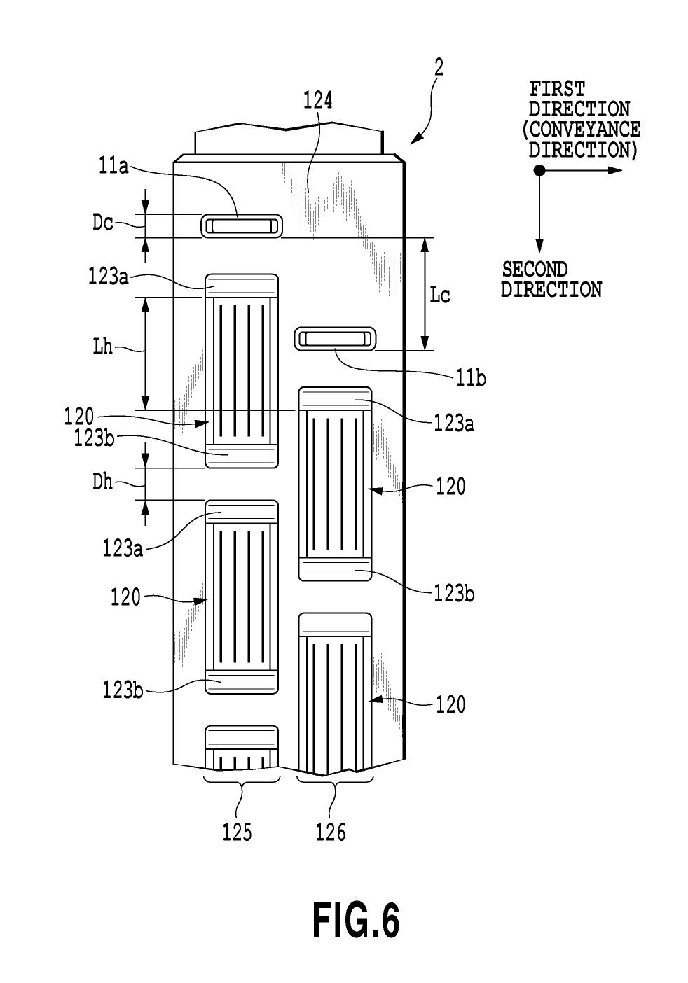

FIG. 6 is an imaginary view of a partial enlargement, showing a positional relationship between the nozzle chips 120 of the print head 2 and the suction nozzles 11. For two staggered arrays, one nozzle chip 120 in one array and one nozzle chip 120 in the other array, which is adjacent to the first nozzle chip 120, are separated at a predetermined distance Lh in the second direction. The two suction nozzles 11 are a first suction nozzle 11a, correlated with a first nozzle chip array 125, and a second suction nozzle 11b, correlated with a second nozzle chip array 126. In the first direction, the gap between the first suction nozzle 11a and the second suction nozzle 11b is equal to the gap between the first nozzle chip array 125 and the second nozzle chip array 126 (a distance measured between the centers). Further, the first suction nozzle 11a and the second suction nozzle 11b are so arranged that the openings of the suction nozzles 11a and 11b are positioned within a range that covers, in the first direction, nozzle arrays included in the nozzle chips 120 of the corresponding chip arrays. The first suction nozzle 11a and the second suction nozzle 11b are shifted in position a distance Lc in the second direction. In the second direction, the shift distance Lh between the nozzle chips 120 is equal to the shift distance Lc between the suction nozzles 11. In this case, being “equal” does not necessarily mean that these two distances completely match, and includes the idea that the distances are almost equal, and the expression “equal”, in the present invention refers to this meaning. “Almost equal” here includes a degree such that a moment exists at which, at the same time, the first suction nozzle 11a contacts a seal portion 123a and the second suction nozzle 11b contacts a seal portion 123b. In other words, the equality between the shift distance Lh and the shift distance Lc is only to a degree, so that it is not always true that the two suction nozzles 11 do not touch the seal portions 123 of their corresponding nozzle chips 120. As described above, the first suction nozzle 11a and the second suction nozzle 11b are shifted in the second direction, in correlation with the shift between the first nozzle chip array 125 and the second nozzle chip array 126 that are adjacent to each other.

The first suction nozzle 11a and the second suction nozzle 11b have a width Dc in the second direction. The width Dc is a range for covering part of the nozzle arrays in the second direction, and corresponds to several to several tens of nozzles. For the individual chip arrays of the print head 2 in the second direction, the interval of the nozzle chips 120 adjacent to each other (the first nozzle chip and the second nozzle chip) in the same array, i.e., the gap from the end of the seal portion 123 to the end of the other seal portion 123, is a distance Dh. When the distance Dc and the distance Dh are compared, a relationship Dc<Dh is established. When this positional relationship is satisfied, the interval of the adjacent suction nozzles 11 can be narrowed, and the extension of the interval between the nozzle chips 120 in the first direction can be prevented, while an increase in the size of the apparatus can be suppressed.

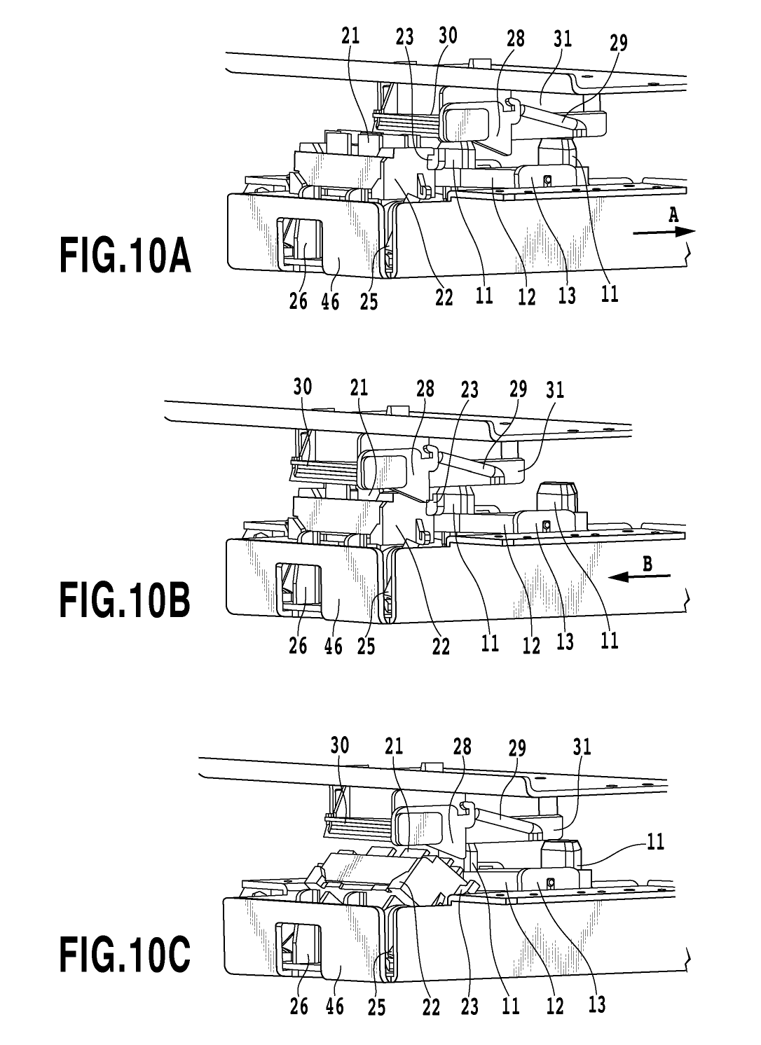

The operation performed for changing the blades 21 from the cleaning position to the retracted position will now be described while referring to FIGS. 10A to 10C. In FIGS. 10A to 10C, a cleaner holder 31 is located outside the cleaning area, at a position opposite that of the cleaning unit 46. The cleaner holder 31 includes a blade cleaner 30 for scraping, from the blades 21, ink that becomes attached during wiping. A release lever 28 is supported at the cleaner holder 31 and is rotatable when urged by the tensile force of a spring 29. Further, the release lever 28 is located at a position where the release lever 28 can contact an abutment portion 23.

FIG. 10A is a diagram showing the state of the blades 21 where the nozzle faces 122 are to be wiped. The blade holder 22 is set in the normal direction, and the blade faces of the blades 21 are set in a direction perpendicular to the nozzle faces of the print head 2, i.e., set at the cleaning position. In this state, the distal ends of the blades 21 are positioned closer to the nozzle faces of the print head 2 than are the distal ends of the suction nozzles 11. When the cleaning unit 46 is moved in a direction indicated by an arrow A in FIG. 10A, the blades 21 contact the blade cleaner 30, and ink and dust attached to the blades 21 is scraped off by the blade cleaner 30. Since during this operation the abutment portion 23 of the cleaning unit 46 is brought into contact with the slope of the release lever 28, the slope of the release lever 28 is pushed by the abutting portion 23, and is gradually pivoted against the force of the spring 29. Thereafter, when the abutment portion 23 has passed the slope of the release lever 28, the release lever 28 is returned to the original state by the urging force of the spring 29.

FIG. 10B is a diagram showing the state wherein the cleaning by the blades 21 has been completed. When in this state the cleaning unit 46 is moved in a direction indicated by an arrow in FIG. 10B, the abutment portion 23 is brought into contact with the end face of the release lever 28. At this time, since the release lever 28 is fixedly held by the engagement portion of the cleaner holder 31, the release lever 28 will not be pivoted, regardless of how the release lever 28 is pushed in the direction B. Therefore, the abutment portion 23 is pressed by the release lever 28, and the blade holder 22 is rotated, against the tensile force of the spring 25, in an opposite direction to the direction in which the cleaning unit 46 is traveling. When the blade holder 22 has been turned, the tensile force of the spring 25 becomes an effective force exerted in a direction for maintaining the rotated state.

FIG. 10C is a diagram showing the state obtained when the blade holder 22 has been turned. The blade holder 22 is inclined, and the blades 21 are set at the retracted position, so that the blade faces are inclined relative to the nozzle faces 122 of the print head 2. In this state, the distal ends of the blades 21 are located at positions at a greater distance than the cleaning position, relative to the nozzle faces 122, and do not contact the nozzle faces 122. That is, in the third direction, the distal ends of the suction nozzles 11, i.e., the portions of the suction means nearest the nozzle faces 122, are positioned between the distal ends of the blades 21 at the cleaning position and the distal ends of the blades 21 at the retracted position.

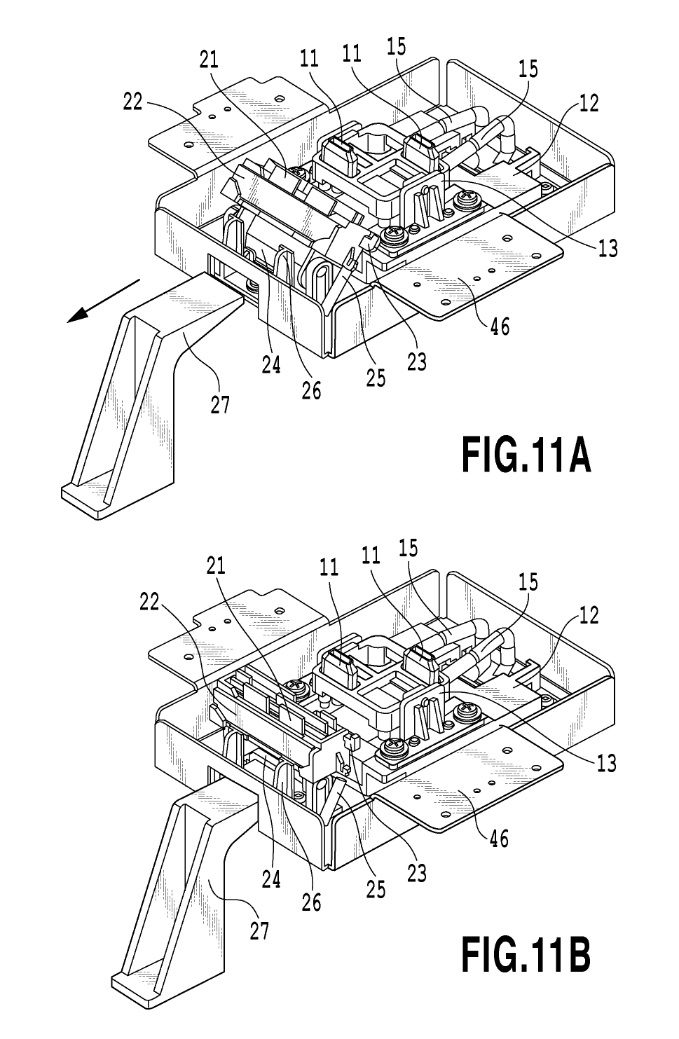

The operation for changing the blades 21 from the retracted position to the cleaning position will be described while referring to FIGS. 11A and 11B. In the state shown in FIG. 11A where the blades 21 are located at the retracted position, the cleaning unit 46 is moved in a direction indicated by an arrow. The abutment portion 23 of the blade holder 22 is brought into contact with the distal end of the trigger lever 27, which is securely fixed to the frame 47. When the cleaning unit 46 is moved further, the blade holder 22 is pushed by the trigger lever 27 and pivoted, and the blades 21 are moved to the cleaning position shown in FIG. 11B. The position changing operation is thus completed.

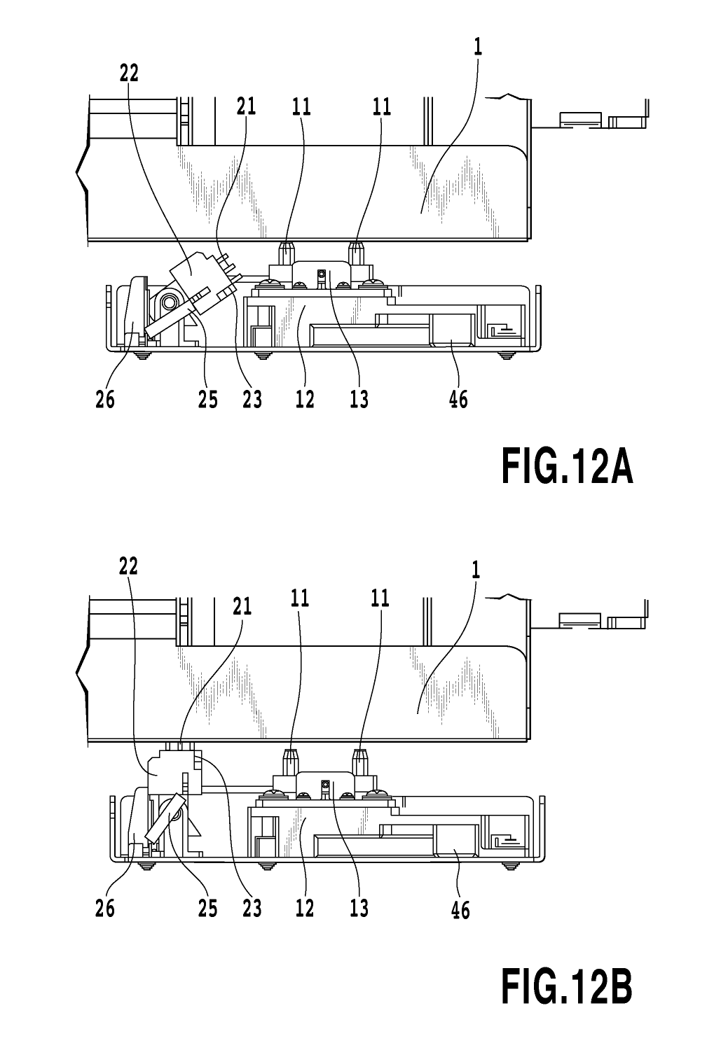

FIGS. 12A and 12B are side views for explaining the operation of the cleaning mechanism. The state in FIG. 12A shows the operation in a suction mode in which the print head 2 is being cleaned using the suction nozzles 11. The state in FIG. 12B shows the operation in a wiping mode in which the print head 2 is being cleaned using the blades 21.

In the suction mode, the blades 21 are set at the retracted position, as shown in FIG. 12A. The print head 2 is set and maintained at the position in the third direction (the suction mode position), so that the nozzle faces 122 of the print head 2 contact the distal ends of the suction nozzles 11. When the cleaning unit 46 is moved in the longitudinal direction (the second direction) while the pressure inside the suction nozzles 11 is being reduced by a pressure-reduction device, ink and dust attached to the nozzles can be drawn in through the suction nozzles 11 and removed. During the movement of the cleaning unit 46 in the second direction, the suction nozzles 11 are pressed down in the third direction when passing over the seal portions 123, which are raised more than the nozzle faces 122 on the print head 2. As described above, since the suction holder 12 of the cleaning unit 46 is displaceable in a direction opposite the nozzle faces 122 (the third direction), the movement of the suction nozzles 11 can be guided by the displacement of the suction holder 12, even when the suction nozzles 11 are pressed down in the third direction. It should be noted that when cleaning using suction is being performed, contact of the suction nozzles 11 with the nozzle faces 122 is not requisite. Cleaning by using suction can also be performed by reducing the pressure in the state wherein the suction nozzles 11 are positioned extremely close to the nozzle faces 122, without contacting each other. That is, in the suction mode, the suction nozzles 11 and the nozzle faces 122 need only be in a state where they are close to each other (including in the state where they contact each other).

Since the distance Lh and the distance Lc are equal, as shown in FIG. 6, the first suction nozzle 11a and the second suction nozzle 11b approach and face, at the same timing, the seal portions 123 of the nozzle chips 120 of the first and second chip arrays, respectively. Accordingly, also at the same timing, the first suction nozzle 11a and the second suction nozzle 11b face the nozzle arrays of the nozzle chips 120 of the first and second chip arrays. When the suction nozzles 11 climb to a step difference at the seal portions 123, a force for a direction to tilt the suction holder 12 is applied via the suction nozzles 11 to the suction holder 12, which is then tilted. Further, when the suction nozzles 11 are climbing up the seal portions 123, the suction nozzles 11 are pressed down and displaced in the third direction. Since the timing at which the first suction nozzle 11a climbs to the seal portion 123 of one array is substantially the same as the timing at which and the second suction nozzle 11b climbs to the seal portion 123 of the other array, tilting of the suction holder 12 is performed by the two suction nozzles with almost the same timing. Further, almost at the same timing, the first suction nozzle 11a and the second suction nozzle 11b are pressed down in the third direction. Therefore, during a period wherein cleaning by suction using the first suction nozzle 11a and the second suction nozzle 11b is performed, a suction force will not be unstable even by tilting, or retracting the suction holder 12. For the above described reason, the reliability for cleaning performed using the nozzles is improved.

In the suction mode, the moving mechanism reciprocally moves the cleaning unit 46 in the second direction, and the pressure-reduction device is controlled so that the pressure inside the suction nozzles 11, i.e., suction force, differs between when the cleaning unit 46 is moved forward and when it is moved backward. Specifically, the pressure provided for the suction nozzles 11 for the backward movement of the cleaning unit 46 is more greatly reduced than is the pressure for the forward movement. Furthermore, in the suction mode, the cleaning unit 46 reciprocally moves in the second direction at a speed that differs between the forward movement and the backward movement. Specifically, the speed for the backward movement is lower than for the forward movement. When a suction process is to be performed during both the forward and backward movements, most of ink and dust is collected by the first backward movement, and only a small amount of the remaining ink and dust is removed by the succeeding forward movement. Therefore, when the pressure for the backward path along which more ink is to be drawn in is reduced more greatly than is the pressure for the forward path, and/or the cleaning unit 46 is moved more slowly, at a lower moving speed, through the first movement a large amount of ink and dust can be collected by suction. For the forward path, when the pressure is reduced less and/or the moving speed is increased, power consumption, operating noise, and/or the total period required for the reciprocal movement can be reduced.

In the wiping mode, the blades 21 are changed to the cleaning position, as shown in FIG. 12B. The position of the print head 2 in the third direction, i.e., the wiping mode position, is set and maintained, so that the distal ends of the blades 21 appropriately contact the nozzle faces 122 of the print head 2. At this time, the distal ends of the suction nozzles 11 and the nozzle faces 122 of the print head 2 are separated by a greater distance from the state shown in FIG. 12A. Here, the pressure-reduction device is halted. When the cleaning unit 46 is then moved in the second direction, the blades 21 wipe the nozzle faces 122 to remove ink and dust there-from.

As described above, the cleaning mechanism has two operating modes, the wiping mode and the suction mode, and employs the same cleaning unit 46 to selectively perform either one of the modes in the individual cleaning directions.

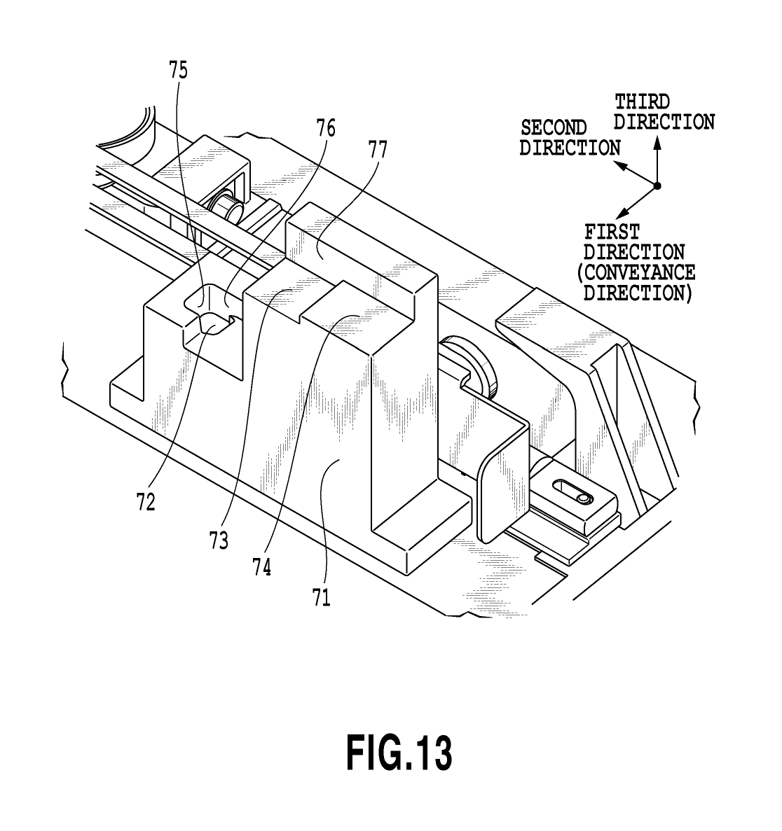

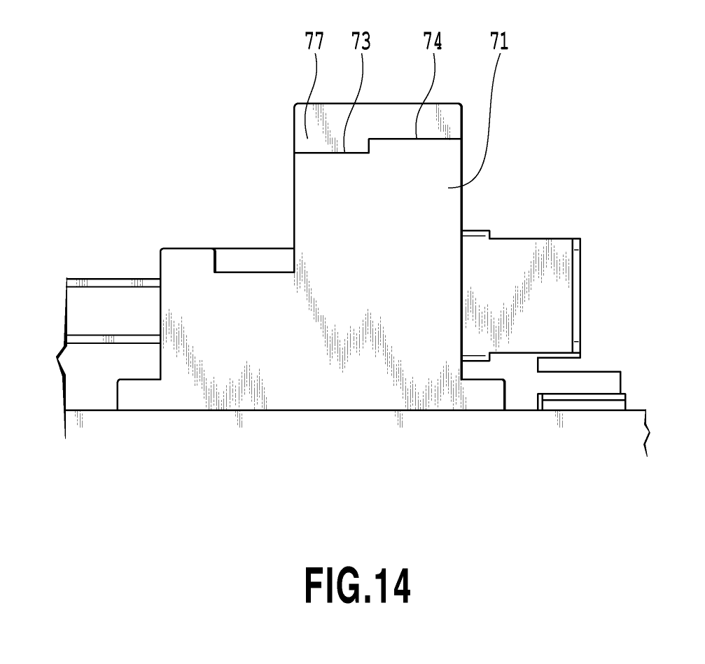

FIG. 13 is a perspective view of one of the positioning members 71 provided for the cleaning section 6, and FIG. 14 is a side view of the positioning member 71. Each of the positioning members 71 has a first third-directional abutment face 73, a second third-directional abutment face 74 and a third third-directional abutment face 72, all of which are formed at different heights in the direction (the third direction) perpendicular to the nozzle faces 122. The positioning member 71 also includes first-directional abutment faces 76 and 77, which abut upon a head positioning member 81 in the first direction, and a second-directional abutment face 75, which abuts upon the head positioning member 81 in the second direction.

FIG. 15A is a diagram showing a positional relationship (capping position) for the positioning member 71 and the head positioning member 81 in the capping process. FIG. 15B is a diagram showing a positional relationship (a suction mode position) for the positioning member 71 and the head positioning member 81 in the suction mode. FIG. 15C is a diagram showing a positional relationship (a wiping mode position) for the positioning member 71 and the head positioning member 81 in the wiping mode.

Referring to FIG. 15A, when the positioning member 71 provided for the cleaning section 6 is at the capping position, for the first direction the head positioning member 81 provided for the head holder 5 abuts on the first-directional abutment face 76, and for the second direction, abuts on the second-directional abutment face 75. Further, for the third direction, the head positioning member 81 abuts on the third, third-directional abutment face 72, so that the positions of the print head 2 and the cleaning section 6 can be determined. At the capping position, the print head 2 closely contacts the cap 51, and the nozzle faces 122 are covered with the cap 51 to prevent drying of the nozzles.

Referring to FIG. 15B, when the positioning member 71 is at the suction mode position, for the first direction, the head positioning member 81 abuts on the first-directional abutment face 77, and for the third direction, abuts on the first, third-directional abutment face 73. At the suction mode position, the distal ends of the suction nozzles and the nozzle faces 122 of the print head 2 contact each other, and therefore, when the pressure inside the suction nozzles 11 is reduced by the pressure-reduction device, while the cleaning unit 46 is moved in the second direction, ink and dust attached to the nozzles can be removed, through the suction nozzles 11, by suction.

Referring to FIG. 15C, when the positioning member 71 is at the wiping mode position, for the first direction the head positioning member 81 abuts on the first-directional abutment face 77, and for the third direction, abuts on the second, third-directional abutment face 74. At the wiping mode position, the distal ends of the blades 21 appropriately contact the nozzle faces 122 of the print head 2, and therefore, when the cleaning unit 46 is moved in the second direction, the blades 21 wipe the nozzle faces 122 to remove ink and dust there-from.

The characteristics of the first embodiment are that cleaning is performed in the suction mode following the wiping mode, and that the traveling direction of the cleaning unit 46 (the cleaning direction) differs between the wiping mode and the suction mode. That is, the forward path in the second direction (a first cleaning direction) is selected for the direction in which the cleaning unit 46 moves in the wiping mode, and the backward path in the second direction (a second cleaning direction) is selected for the direction in which the cleaning unit 46 moves in the suction mode. It should be noted that the forward path in the second direction indicates a path in a direction indicated by an arrow A shown in FIG. 10A, and the backward path in the second direction is a path in a direction indicated by an arrow B in FIG. 10B. In the wiping mode, wiping can be performed only in the forward path direction (the first cleaning direction) because of the restriction imposed by the above described switching mechanism. That is, in a case wherein wiping is performed during the backward movement (the second cleaning direction), the blades 21 will be returned to the retracted position due to the friction force caused between the blades 21 and the nozzle faces 122. Therefore, in the suction mode, it is better to perform wiping along the backward path to reduce the time required to move the wiper unit.

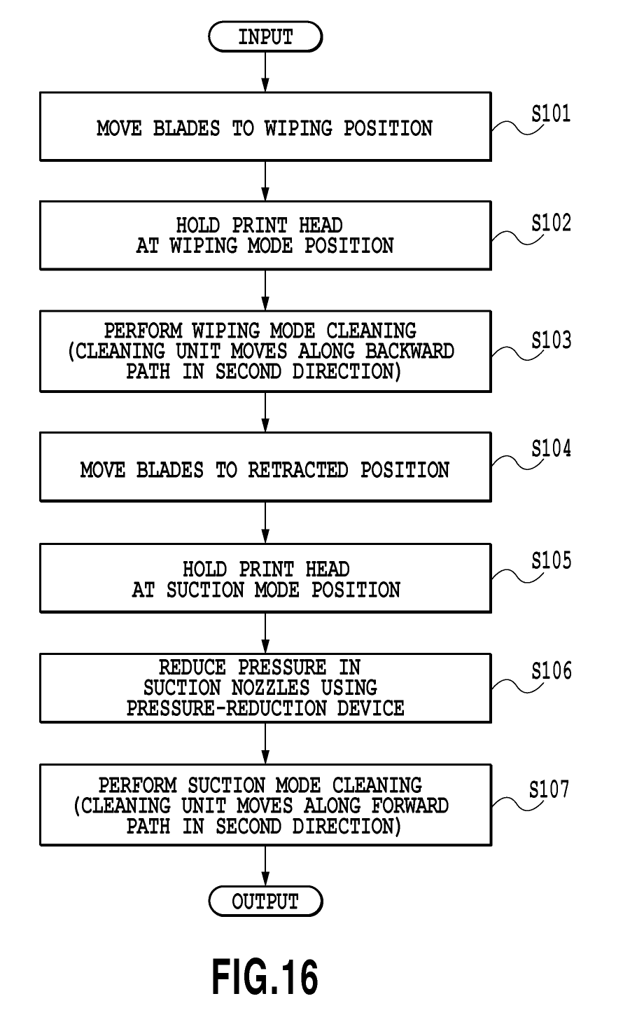

FIG. 16 is a flowchart showing the cleaning operation performed for the first embodiment.

To perform cleaning in the wiping mode, the position for the blades 21 is changed to the cleaning position, as shown in FIG. 12B (S101), and the positioning members 71 and the head positioning members 81 are held at the wiping mode position, as shown in FIG. 15C (S102). Then, the cleaning unit 46 is moved along the forward path in the second direction, and the wiping mode is initiated (S103). The nozzle faces 122 and the base substrate 124, which is a chip mounting face, are wiped by the blades 21 to remove ink and dust. In this manner, cleaning of the nozzle faces 122 can be performed without an ejection of ink through the nozzles being required. To actuate the suction mode, the position for the blades 21 is changed to the retracted position, as shown in FIG. 12A (S104), and as shown in FIG. 15B, the positioning members 71 and the head positioning members 81 are held at the suction mode position (S105). Then, the pressure in the suction nozzles 11 is reduced by the pressure-reduction device (S106), and the suction mode cleaning is performed by moving the cleaning unit 46 along the backward path in the second direction (S107). In this manner, ink and dust attached to the nozzle faces 122 and the nozzles are collected by a suction force through the suction nozzles 11. As a result, the cleaning can be performed, while the consumption of ink from the nozzles is suppressed.

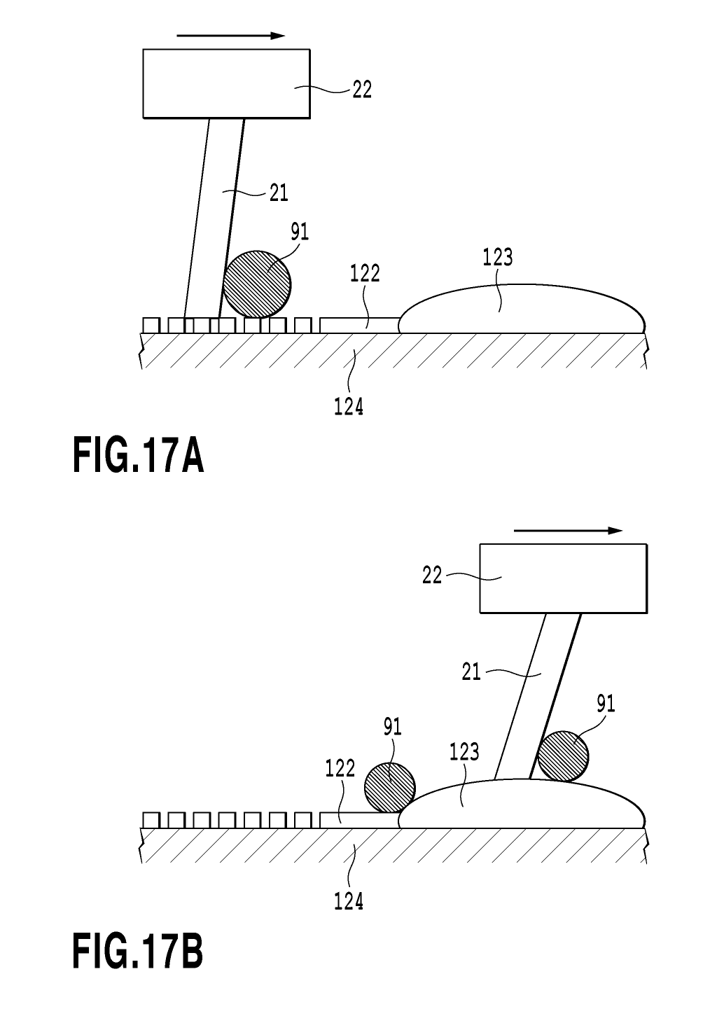

FIG. 17A is a diagram showing the state, for the first embodiment, before the blade 21 is moved from the nozzle face 122 to the seal portion 123. In the state in FIG. 17A, the blade 21 have wiped the nozzle face 122 at the boundary between the nozzle face 122 and the seal portion 123 in FIG. 5B. In order to correspond to FIG. 5B, FIG. 17A is provided by turning the cleaning unit 46 being upside down. The blade holder 22 moves along the forward path in the second direction (to the right in FIG. 17A), at a speed of five inches per second. At the time when the blade 21 is moved across the nozzle face 122 to approach the seal portion 123, ink and dust 91 are moved across the nozzle face 122 while in contact with the blade 21 and the nozzle face 122, so that the ink and dust 91 can be removed from the nozzle face 122.

FIG. 17B is a diagram showing the state after the blade 21 has moved from the nozzle face 122 to the seal portion 123. In the state shown in FIG. 17B, the blade 21 has wiped the seal portion 123 at the boundary between the nozzle face 122 and the seal portion 123. The blade holder 22 moves along the forward path in the second direction (to the right in FIG. 17B), at a speed of five inches per second. At the time when the blade 21 has moved from the nozzle face 122 to the seal portion 123, a part of the ink and dust 91 on the nozzle face 122 is attached at the boundary between the nozzle face 122 and the seal portion 123 because there is a difference in height between the nozzle face 122 and the seal portion 123. The other part of the ink and dust 91 is moved across the seal portion 123 in contact with the blade 21 and the seal portion 123.

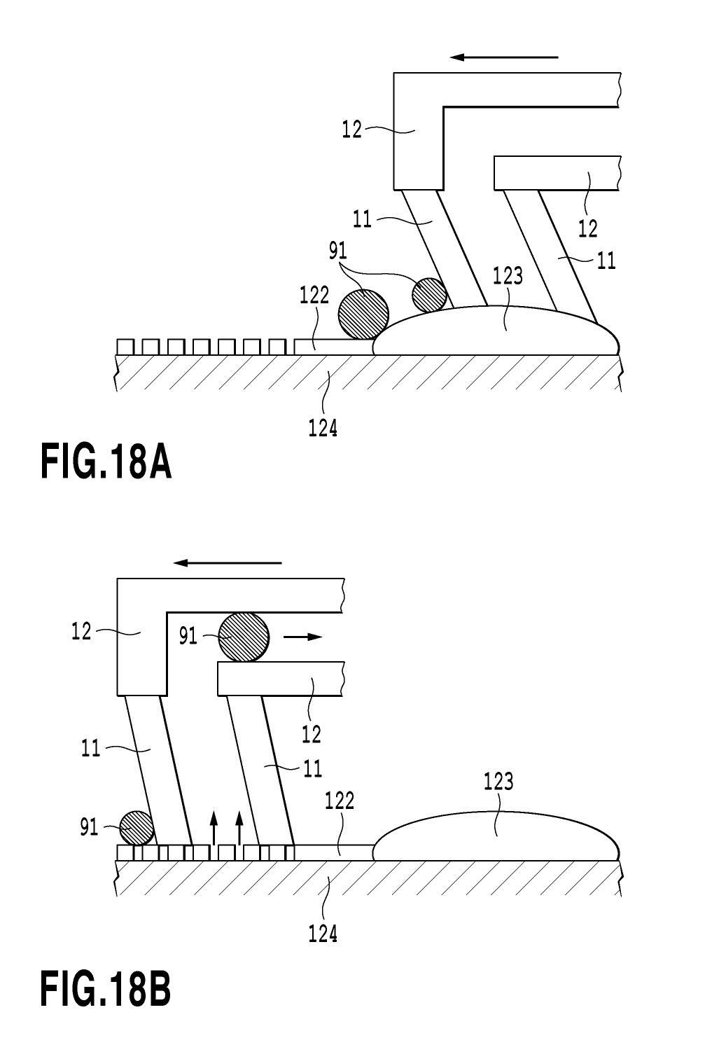

FIG. 18A is a diagram showing the state, for the first embodiment, before the suction nozzles 11 are moved from the seal portion 123 to the nozzle face 122. In the state in FIG. 18A, the suction nozzles 11 have wiped the seal portion 123 at the boundary between the nozzle face 122 and the seal portion 123, shown in FIG. 5B. The suction holder 12 moves along the backward path in the second direction (to the left in FIG. 18A), at a speed of 0.5 inches per second. In this state, i.e., before the suction nozzles 11 are moved from the seal portion 123 to the nozzle face 122, the ink and dust 91 are attached to the boundary between the nozzle face 122 and the seal portion 123.

FIG. 18B is a diagram showing the state, for the first embodiment, when the suction nozzles 11 have moved from the seal portion 123 to the nozzle face 122. In the state shown in FIG. 18B, the suction nozzles 11 have wiped the nozzle face 122 at the boundary between the nozzle face 122 and the seal portion 123 in FIG. 5B. The suction holder 12 moves along the backward path in the second direction (to the left in FIG. 18B), at a speed of 0.5 inches per second. At the time when the suction nozzles 11 have moved from the seal portion 123 to the nozzle face 122, the ink and dust 91 at the boundary between the nozzle face 122 and the seal portion 123 are scraped off by the suction nozzles 11. A part of the scraped off ink and dust 91 is drawn in, together with ink and bubbles that are collected from the nozzles by the reduced pressure inside the suction nozzles 11. The other part of the ink and dust 91 is moved along the nozzle face 122, while contacting the suction nozzles 11 and the nozzle face 122. With the above described arrangement, the ink and dust 91 attached at the boundary between the nozzle face 122 and the seal portion 123 can be removed.

### Second Embodiment

The wiping mode and the suction mode have been employed in the first embodiment; however, when recovery of the nozzles is more important than a reduction in the consumption of ink, it is preferable that cleaning in the suction mode be performed two times.

In a second embodiment of the present invention, the suction mode cleaning is to be performed twice, and the direction of travel of the cleaning unit 46 (the cleaning direction) differs between the first suction mode cleaning and the second suction mode cleaning. That is, the forward path in the second direction is selected for the direction in which the cleaning unit 46 is moved in the first suction mode, and the backward path in the second direction is selected as the direction in which the cleaning unit 46 is moved in the second suction mode. When cleaning is to be performed only in the suction mode, there is no limitation on the cleaning direction, and either forward cleaning or backward cleaning may be performed first.

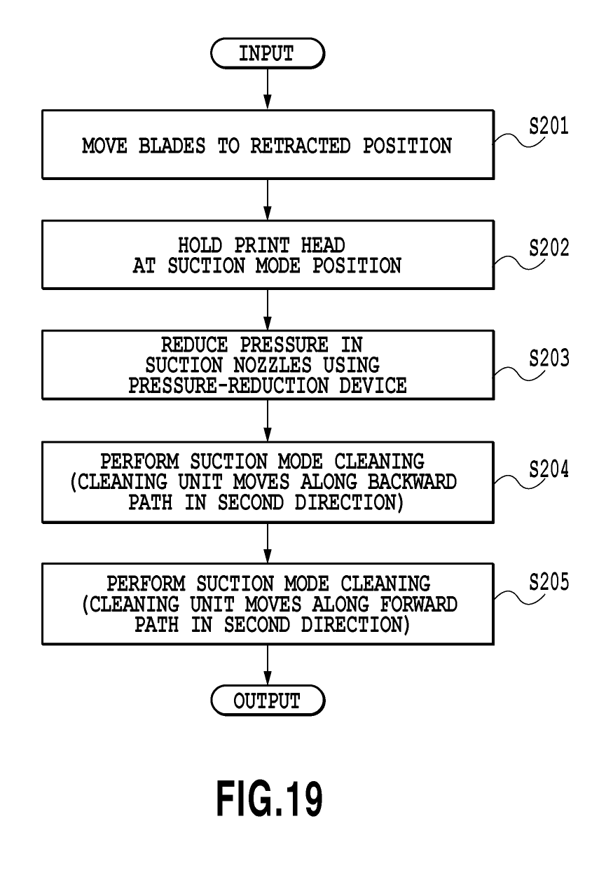

FIG. 19 is a flowchart showing the cleaning operation performed for the second embodiment. To perform the first suction mode operation, the position for the blades 21 is changed to the retracted position, as shown in FIG. 12A (S201), and the positioning member 71 and the head positioning member 81 are held at the suction mode position, as shown in FIG. 16B (S202). Then, the pressure in the suction nozzles 11 is reduced by a pressure-reduction device (S203), and the cleaning unit 46 is moved along the backward path in the second direction to perform the first suction mode operation (S204). Thus, the suction nozzles 11 are employed to collect, using suction, ink and dust attached to the nozzle faces 122 and the nozzles. Thereafter, in the state wherein the suction mode position and the reduced pressure condition are maintained, the cleaning unit 46 is moved along the forward path in the second direction to perform the second suction mode operation (S205). The cleaning operation performed in this manner will increase the amount of ink consumed more greatly than in the first embodiment, but can give a higher priority to recovery of the nozzles.

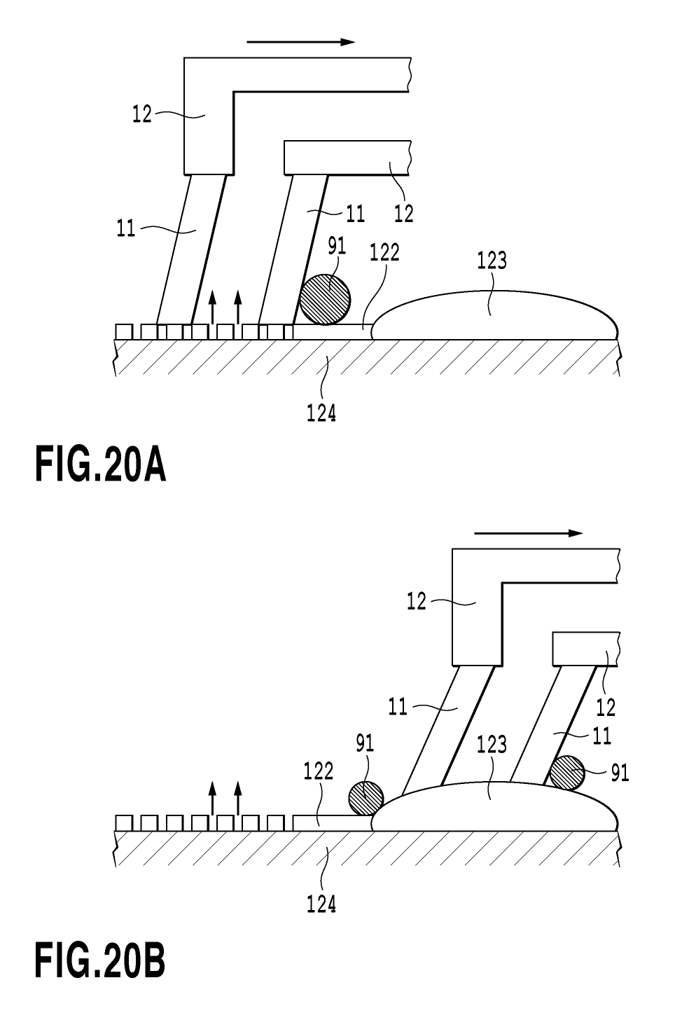

FIG. 20A is a diagram showing the state, for the second embodiment, before the suction nozzles 11 are moved from the nozzle face 122 to the seal portion 123. In the state in FIG. 20A, the suction nozzles 11 have cleaned the nozzle face 122 at the boundary, shown in FIG. 5B, between the nozzle face 122 and the seal portion 123. In this case, the cleaning unit 46 is shown upside down to correspond with that in FIG. 5B. The suction holder 12 moves along the forward path in the second direction (to the right in FIG. 20A) at a speed of 0.5 inches per second. In the state before the suction nozzles 11 are moved from the nozzle face 122 to the seal portion 123, ink and dust 91 is moved across the nozzle face 122 by contacting the suction nozzles 11 and the nozzle face 122, so that the ink and dust 91 can be scraped from the nozzle face 122. Further, since part of the ink and dust 91 can be removed by suction via the suction nozzles 11, together with ink and bubbles that are collected from the nozzles by the reduced pressure inside the suction nozzles 11, the absolute amount of the ink and dust 91 can be reduced more than that in the first embodiment.

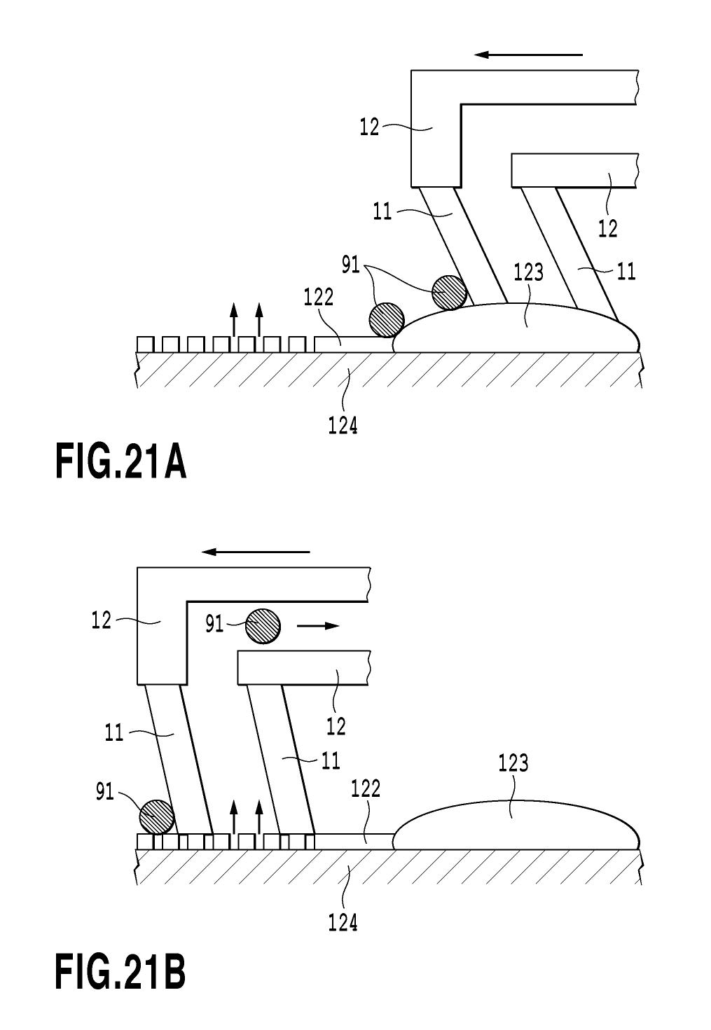

FIG. 20B is a diagram showing the state, for the second embodiment, after the suction nozzles 11 have moved from the nozzle face 122 to the seal portion 123. In the state shown in FIG. 20B, the suction nozzles 122 have cleaned the seal portion 123 at the boundary, shown in FIG. 5B, between the nozzle face 122 and the seal portion 123. The suction holder 12 moves along the forward path in the second direction (to the right in FIG. 21A), at a speed of 0.5 inches per second. When the suction nozzles 11 have moved from the nozzle face 122 to the seal portion 123, one part of the ink and dust 91 attached to the nozzle face 122 remains at the boundary between the nozzle face 122 and the seal portion 123 because there is a difference in heights between the nozzle face 122 and the seal portion 123. The other portion of the ink and dust 91 is moved across the seal portion 123 while in contact with the suction nozzles 11 and the seal portion 123.

FIG. 21A is a diagram showing the state, for the second embodiment, before the suction nozzles 11 are moved from the seal portion 123 to the nozzle face 122. In the state in FIG. 21A, the suction nozzles 11 have cleaned the seal portion 123 at the boundary, shown in FIG. 5B, between the nozzle face 122 and the seal portion 123. The suction holder 12 moves along the backward path in the second direction (to the left in FIG. 21A), at a speed of 0.5 inches per second. In the state before the suction nozzles 11 are moved from the seal portion 123 to the nozzle face 122, the ink and dust 91 is attached to the boundary between the nozzle face 122 and the seal portion 123.

FIG. 21B is a diagram showing the state, for the second embodiment, after the suction nozzles 11 have moved from the seal portion 123 to the nozzle face 122. In the state in FIG. 21B, the suction nozzles 11 have wiped the nozzle face 122 at the boundary, shown in FIG. 5B, between the nozzle face 122 and the seal portion 123. The suction holder 12 moves along the backward path in the second direction (to the left in FIG. 21B), at a speed of 0.5 inches per second. When the suction nozzles 11 have moved from the seal portion 123 to the nozzle face 122, the ink and dust 91 attached at the boundary between the nozzle face 122 and the seal portion 123 is scraped off by the suction nozzles 11. Part of the ink and dust 91 thus scraped off is collected by suction, via the suction nozzles 11, together with ink and bubbles drawn in by the reduced pressure inside the suction nozzles 11. The other part of the ink and dust 91 is moved along the nozzle face 122, in contact with the suction nozzles 11 and the nozzle face 122. With the above described arrangement, the ink and dust 91 can be removed from the boundary between the nozzle face 122 and the seal portion 123.

An undesirable arrangement is that the wiping mode operation is performed twice, and that the direction of travel of the cleaning unit 46 differs between the first wiping mode and the second wiping mode. This is because, in the first wiping mode, the ink and dust 91 remain on one side, at the boundary between the nozzle face 122 and the seal portion 123, and in the second wiping mode, these ink and dust 91 are moved to the boundary between the nozzle face 122 and the seal portion 123 on the opposite side in the nozzle array direction of the same chip. When the ink and dust 91 have accumulated at the boundary between the nozzle face 122 and the seal portion 123, the absolute amount of the ink and dust 91 to be attached to the blades 21 is increased, and the wiping function is degraded. As a result, a probability is increased that the ink and dust 91 will remain on the nozzle face 122 after wiping has been performed.

The wiping speeds for the first embodiment and the second embodiment have been five inches per second for the wiping mode, and 0.5 inches per second for the suction mode; however, these speeds are not limited to these values. Since, for the wiping mode, a correlation between the wiping speed and the efficiency for removal of ink and dust is low, from the viewpoint of throughput, it is preferable that the wiping speed for removing ink and dust be as high as possible. For the suction mode, however, there is a high correlation between the wiping speed and the efficiency for removal of ink and dust (as the wiping speed is low, the amount of ink drawn in via the nozzles is increased and recovery of nozzles is improved), and therefore, from the viewpoint of nozzle recovery, it is preferable that the wiping speed be as low as possible.

In the above embodiments, two staggered arrays of the nozzle chips 120 have been provided as an example; however, another regular arrangement may be employed. In either case, for the print head 2, a plurality of first nozzle chips and a plurality of second nozzle chips, each having nozzle arrays, are arranged to form different arrays in the second direction, and the first nozzle chip array and the second nozzle chip array that are adjacent to each other are shifted in the second direction. Further, the nozzle arrays, included in the nozzle chips of the first and second arrays adjacent to each other, partially overlap in the second direction.

In the above embodiments, a case wherein the cleaning unit 46 is moved relative to the fixed print head 2 has been described. The present invention is not limited to this case, and may also be applied for a system wherein a print head moves relative to a cleaning unit to perform cleaning. That is, the present invention can be applied for a printing apparatus that includes an ink suction unit that is to be moved, relative to nozzles included in the nozzle arrays of a print head, in a direction in which the nozzle arrays are formed.

In the above embodiments, a case wherein cleaning with the blades is enabled, in only the first cleaning direction, has been described. However, cleaning in the second direction may also be enabled. Further, a structure wherein the blades and the nozzles are moved together has been employed; however, a moving mechanism for moving these components separately may also be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-027195, filed Feb. 10, 2011, which is hereby incorporated by reference herein in its entirety.

What is claimed is:

1. An ink jet printing apparatus comprising:
a print head having a plurality of nozzle chips, each having nozzle arrays arrayed on a common chip mounting face of the print head;
a first cleaning unit configured to wipe the chip mounting face including wiping nozzle faces of the nozzle chips;
a second cleaning unit configured to suction the chip mounting face including suctioning nozzle faces of the nozzle chips;
a moving mechanism configured to move the first and second cleaning units relative to the print head in a first cleaning direction and in a second cleaning direction opposite to the first cleaning direction; and
a selection unit configured to select a cleaning unit to be used for cleaning in the first cleaning direction and a cleaning unit to be used for cleaning in the second cleaning direction from the first and second cleaning units, respectively.

2. The ink jet printing apparatus according to claim 1, wherein the selection unit selects the first cleaning unit for cleaning in the first cleaning direction, and after cleaning has been performed, selects the second cleaning unit for cleaning in the second cleaning direction.

3. The ink jet printing apparatus according to claim 1, wherein the selection unit selects the second cleaning unit for cleaning in the second cleaning direction, and after cleaning has been performed, again selects the second cleaning unit for cleaning in the first cleaning direction.

4. The ink jet printing apparatus according to claim 1, wherein the selection unit selects the second cleaning unit for cleaning in the first and second cleaning directions.

5. The ink jet printing apparatus according to claim 1, wherein a travel speed of the second cleaning unit when the second cleaning unit is used for cleaning is lower than a travel speed of the first cleaning unit when the first cleaning unit is used for cleaning.

6. The ink jet printing apparatus according to claim 1, wherein the moving mechanism moves the first and second cleaning units together.

7. The ink jet printing apparatus according to claim 1, wherein the first cleaning unit is operable for cleaning only in the first cleaning direction.

8. The ink jet printing apparatus according to claim 1, wherein the first cleaning unit comprises a blade formed of elastic material and the blade bends when pressed against the chip mounting face.

9. The ink jet printing apparatus according to claim 1, wherein the second cleaning unit comprises a suction nozzle in which pressure is reduced so as to suction ink from the nozzle arrays.

10. The ink jet printing apparatus according to claim 1, wherein the first and second cleaning units are movably held between a cleaning position and a retracted position, respectively, and
wherein further comprises a switching unit configured to move one of the first and second cleaning units from the retracted position to the cleaning position while moving the other of the first and second cleaning unit from the cleaning position to the retracted position.

11. The ink jet printing apparatus according to claim 1, wherein on the chip mounting face, a seal portion is formed at an end of the nozzle chip in a nozzle array direction, and the seal portion protrudes in an ink ejection direction so as to form a step with respect to the nozzle face.
